(19) United States
(12) Patent Application Publication
(10) Pub. No.: US 2005/0046098 A1
(43) Pub. Date: Mar. 3, 2005

(54) Multifunctional shock-resisting structure

(76) Inventors: Chiao-Yu Jen, Taipei (TW); Ching-Shyang Chen, Taipei (TW)

Correspondence Address: Chiao-Yu Jen, PO Box 82-144, Taipei, TW

(21) Appl. No.: 10/647,206

(22) Filed: Aug. 26, 2003

(51) Int. Cl. F16F 1/36

(52) U.S. Cl. 267/153

(57) ABSTRACT

A multifunctional shock-resisting structure is disclosed and the shock-resisting structure comprises (a) an external frame being an open or closed socket body of different shapes; (b) an actuating rod, and the material for the external frame, the braking layer and the actuating rod being different in softness or hardness; and (c) a braking layer being positioned between the external frame and the actuating rod, wherein after the actuating rod is inserted into the external frame the braking layer is filled into the space between the actuating rod and the external frame such that eh inner edge of the external frame and the actuating rod is interconnected by the braking layer.

### BACKGROUND OF THE INVENTION

(a) Technical Field of the Invention

The present invention relates to shock-resisting structure and in particular, to shock-resisting structure which can be installed easily and widely used to provide excellent shock prevention.

(b) Description of Prior Art

Earthquakes that occurred in many parts of the world have caused enormous loss of lives and properties and accordingly it is an important issue to design shock-resisting structure, which can prevent shock or minimize damages as a result of earthquakes. In conventional types of shock-resisting wall structure, a damping wall is provided to a building and this wall can a limited space to contain oil or the like material. Thixotropic property of the oil material provides a shock-resisting function, but the effect of shock-resisting is only about 10% and only one damping wall can be mounted on one wall and the big volume of the window and door, where no damping wall can be mounted, and the expensive cost of installation of the damping wall, this conventional type of shock-resisting structure has drawbacks.

### SUMMARY OF THE INVENTION

Accordingly, it is an object of the present invention to provide a multifunctional shock-resisting multifunctional shock-resisting structure comprising (a) an external frame being an open or closed socket body of different shapes; (b) an actuating rod, and the material for the external frame, the braking layer and the actuating rod being different in softness or hardness; and (c) a braking layer being positioned between the external frame and the actuating rod, wherein after the actuating rod is inserted into the external frame the braking layer is filled into the space between the actuating rod and the external frame such that eh inner edge of the external frame and the actuating rod is interconnected by the braking layer.

Yet another object of the present invention is to provide a multifunctional shock-resisting structure, wherein the entire structure is small and therefore there is lesser restriction and the installation is easy and fast, and the cost of installation is low. Further, the method of installation can be achieved by the method of stacking and the structure can be used in common isolation wall structure, separation wall, shearing wall, or external wall, and/or other main structural wall or other non-main structural wall.

Still another object of the present invention is to provide a multifunctional shock-resisting structure, wherein the structure can be installed on platform or table so as to provide shock resisting to protect the expensive items placed on the table.

Still a further object of the present invention is to provide a multifunctional shock-resisting structure wherein the external frame of the shock-resisting structure can be changed with respect to material (for instance, soundproof material, concrete, etc.) and the method of implementation is convenience and under normal condition, the external frame can withstand a weight exerted and in the course of earthquake, it is a shock-resisting structure.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

These and other objects and advantages will become apparent by reading the detailed description hereinafter together with accompanying drawings, wherein

FIG. 1 is a perspective exploded view of the present invention.

FIGS. 2, 3, and 4 are sectional views in accordance with the present invention.

FIG. 5 is a schematic view showing the mounting of the shock-resisting structure onto the external wall in accordance with the present invention.

FIGS. 6 and 7 are schematic views showing the present invention.

FIG. 8 is a schematic view showing the installation of the shock-resisting structure of the present invention onto the wall surface in another preferred embodiment of the present invention.

FIGS. 9A-9E, 10A-10C, 11A-11C are schematic views of different preferred embodiment in accordance with the present invention.

### DETAILED DESCRIPTION OF THE INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

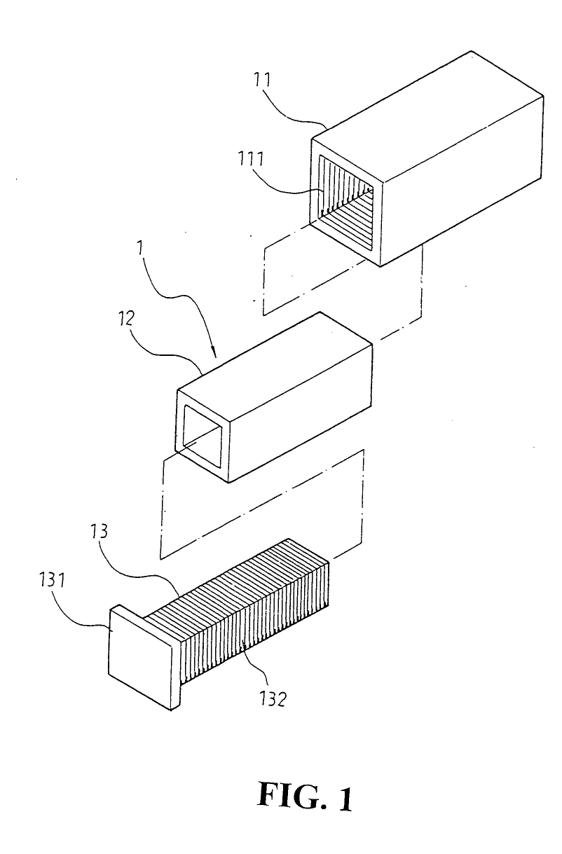

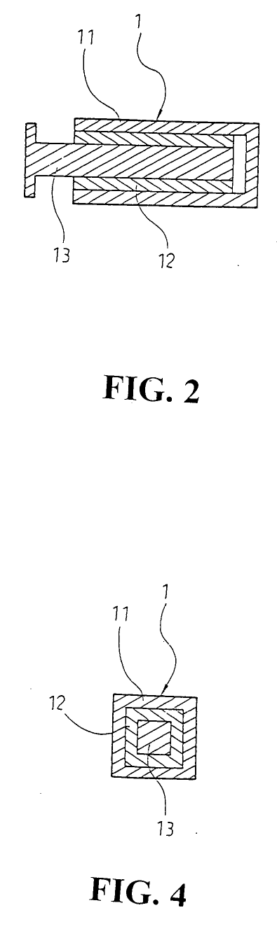

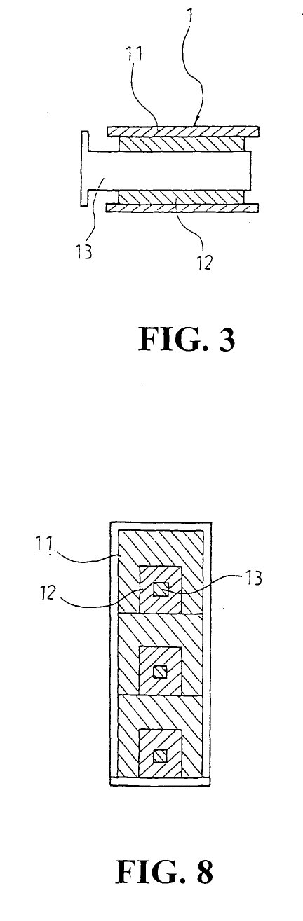

Referring to FIGS. 1, 2, 3 and 4, there is shown a multifunctional shock-resisting structure comprising an external frame 11, a braking layer 12 and an actuating rod 13. The external frame 11 is an opened or a closed socket body and the front end of the actuating rod 13 is mounted with an appropriate connection portion 131. After the actuating rod 13 is inserted into the external frame 11, the space between the inner edge of the external frame 11 and the actuating rod 13 is filled with the braking layer 12 such that the external frame 11 and the actuating rod 13 are connected by the braking layer 12 so as to form the shock-resisting structure 1. The shock-structure 1 can be installed or replaced a separation wall, a partition wall, a shearing wall, an external wall, which is either a main structure of the wall or the non main structure of the wall. The shock-structure 1 can also be used to mount onto a platform, or table such that by using the different hardness of the actuating rod 13, the braking layer 12 and the external frame 11 so that the different of hardness in the material produces deforms of friction, tearing, shearing or compression and the shocking energy is converted into thermal energy or other form of energy for releasing so as to reduce shock.

The material for the external frame 11, the braking layer 12 and the actuating rod 13 is metallic material, non-metallic material, or the mixture of metallic and non-metallic material of different hardness, and the surface of the actuating rod and the inner edge 111 of the external frame 11 can either be smooth, rough, threaded, or zigzag, or slanting threads which facilitates the binding of the braking layer 12 and the changing of the contact area of the inner edge 111 of the external frame 11, the surface 132 of the actuating rod and the braking layer 12.

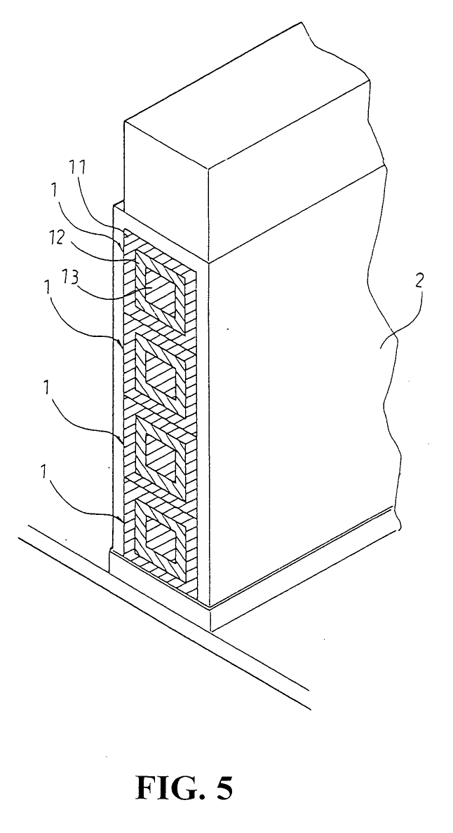

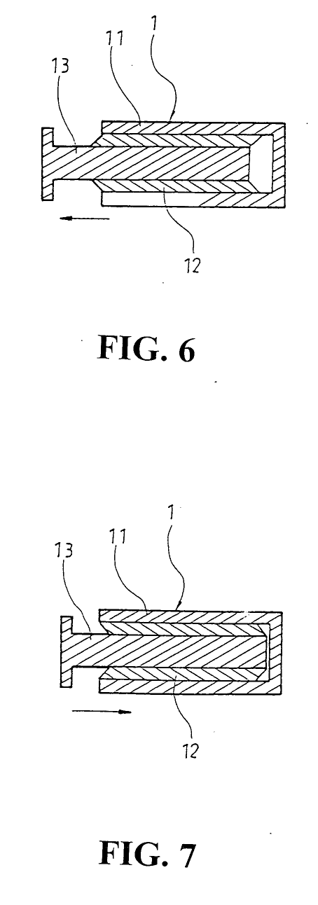

Referring to FIG. 5, the method of stacking is employed to mount the the shock-resisting structure onto the wall 2. After a plurality of shock-resisting structures are stacked, a flame-resisting material is used to cover the wall face 2 of the metallic or non-metallic material so that when an earthquake occurs, as shown in FIGS. 6 and 7, due to the different of hardness of the external frame 11, the braking layer 12 and the actuating rod 13, friction, tearing, shearing and compression deformation are formed as a result of the different hardness of the material. Thus, the shocking energy is converted into thermal energy or other forms of energy and is or are then released.

Referring to FIG. 8, when the shock-resisting structure of the present invention is mounted onto the wall surface 2, the socked like external frame is changed into a substantial arch shape external frame and the structure is then stacked one by one.

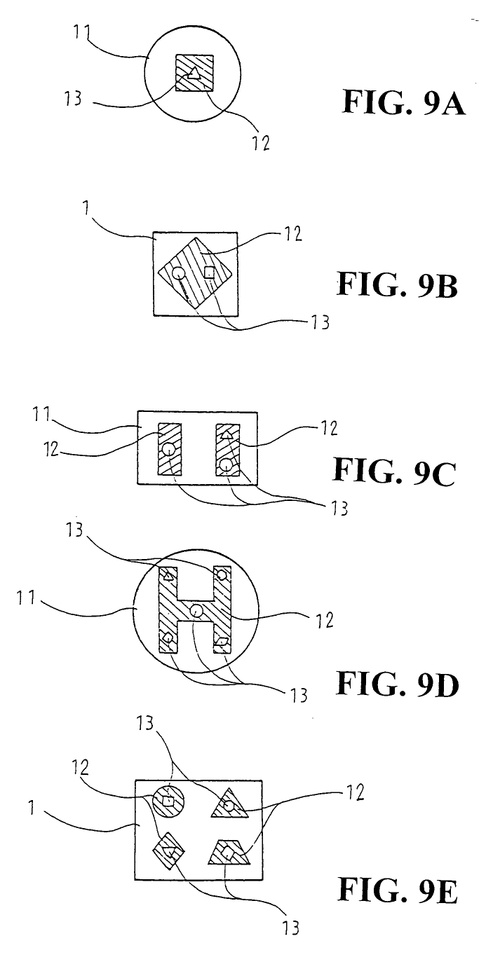

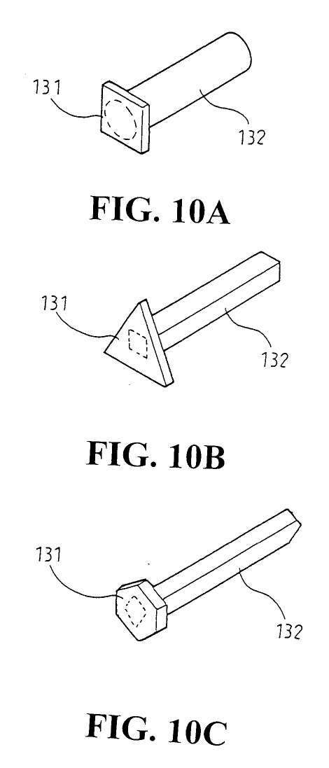

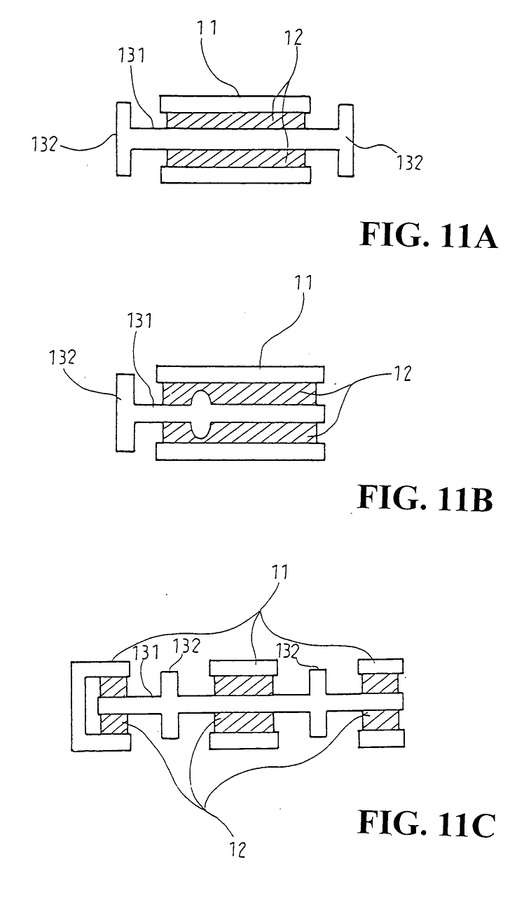

Referring to FIGS. 9A-9E, 10A-10C, and 11A-11C, there are shown various types of shapes and number of external frame 11, the external frame inner edge 111, the actuating rod 13 the connection portion 131 and based on requirement, the external frame or the actuating rod is formed into any optional shape opening and the number of opening is optional so as to change the numbers of contact surfaces with respect to different materials so as to reduce the effect of shock.

In view of the above, the shock-resisting structure of the present invention has advantages as compared to the conventional shock-resisting structure as follows:
1. Small surface area: No restriction to criteria for implementation and the process of installation is convenient, rapid and the effect of shock-resisting is good.
2. The shock-resisting structure can be used or used to replace partition wall, separation wall, shearing wall, external wall of the main structure or the non-main structure, and based on the need of the wall to mount the window, the shock-resisting structure of the present invention will not affect the space or the quality of the space within the building.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-4. (canceled).

5. A multifunctional shock-resisting structure comprising:
an external frame being an open or closed socket body;
an actuating rod having an end inserted into said external frame;
a braking layer being positioned between said external frame and said actuating rod, wherein after said actuating rod is inserted into said external frame, said braking layer is filled into a space between said actuating rod and said external frame such that an inner edge of said external frame and said actuating rod is interconnected by said braking layer; and
material for said external frame, the braking layer and the actuating rod being different hardness.
